(19) United States
(12) Patent Application Publication
(10) Pub. No.: US 2022/0403089 A1
(43) Pub. Date: Dec. 22, 2022

(54) PRODUCTION OF RIGID POLYURETHANE FOAM

(71) Applicant: Evonik Operations GmbH, Essen (DE)

(72) Inventors: Martin Glos, Borken (DE); Jobst Grimminger, Ellerau (DE); Torsten Panitzsch, Henstedt-Ulzburg (DE); Olga Fiedel, Essen (DE)

(73) Assignee: Evonik Operations GmbH, Essen (DE)

(21) Appl. No.: 17/636,546

(22) PCT Filed: Sep. 8, 2020
(86) PCT No.: PCT/EP2020/075000

§ 371 Date: Feb. 18, 2022

(30) Foreign Application Priority Data
Oct. 8, 2019 (EP) 19201881.0

(51) Int. Cl. C08G 18/18; C08G 18/09; C08G 18/22; C08G 18/76; C08G 18/48; C08G 18/42; C08J 9/14; C08J 9/00

(52) U.S. Cl. CPC C08G 18/1816; C08G 18/092; C08G 18/1833; C08G 18/225; C08G 18/7671; C08G 18/48; C08G 18/425; C08G 18/4211; C08J 9/141; C08J 9/0052; C08G 2110/0025; C08J 2203/14; C08J 2375/08; C08J 2205/10

(57) ABSTRACT

What is described is a composition for production of rigid polyurethane foam, comprising at least one isocyanate component, a polyol component, optionally a foam stabilizer, optionally blowing agent, wherein the composition contains at least one catalyst that catalyses the formation of a urethane or isocyanurate bond, wherein the catalyst comprises salts of amino acid derivatives.

### CROSS REFERENCE TO RELATED APPLICATIONS

This application is a 35 U.S.C. § 371 U.S. national phase entry of International Application No. PCT/EP2020/075000 having an international filing date of Sep. 8, 2020, which claims the benefit of European Application No. 19201881.0 filed Oct. 8, 2019, each of which is incorporated herein by reference in its entirety.

### FIELD

The present invention relates to the field of polyurethanes, especially that of rigid polyurethane foams. More particularly, it relates to the production of rigid polyurethane foams using specific salts, and additionally to the use of the foams which have been produced therewith. The present invention concerns rigid polyurethane foams.

### BACKGROUND

Polyurethane (PU) in the context of the present invention is especially understood to mean a product obtainable by reaction of polyisocyanates and polyols or compounds having isocyanate-reactive groups. Further functional groups in addition to the polyurethane can also be formed in the reaction, examples being uretdiones, carbodiimides, isocyanurates, allophanates, biurets, ureas and/or uretonimines. Therefore, PU is understood in the context of the present invention to mean both polyurethane and polyisocyanurate, polyureas, and polyisocyanate reaction products containing uretdione, carbodiimide, allophanate, biuret and uretonimine groups. In the context of the present invention, polyurethane foam (PU foam) is especially understood to mean foam which is obtained as reaction product based on polyisocyanates and polyols or compounds having isocyanate-reactive groups. In addition to the eponymous polyurethane, further functional groups can be formed as well, examples being allophanates, biurets, ureas, carbodiimides, uretdiones, isocyanurates or uretonimines.

The present invention more particularly concerns the formation of polyisocyanurates. This reaction is referred to as trimerization since, in a formal sense, three isocyanate groups react to give an isocyanurate ring.

In the production of rigid polyurethane and polyisocyanurates foams, various catalysts are used in order to positively influence the reaction profile of the foaming and the use properties of the foam to a significant degree. The formation of polyisocyanurates is advantageous here since these lead to good mechanical properties (high compression hardness) and improved flame-retardant properties.

There are various known publications relating to the use of catalysts for improvement of compression hardness or assistance of the trimerization reaction in the production of rigid PU foams.

EP 1 745 847 A1 describes trimerization catalysts based on potassium oxalate and solvents that are inert with respect to the reaction with isocyanates.

WO 2016/201675 describes trimerization catalysts consisting of compositions based on sterically hindered carboxylates and tertiary amines that bear an isocyanate-reactive group.

WO 2013/074907 A1 describes the use of tetraalkylguanidine salts of aromatic carboxylic acids as catalysts for polyurethane foams.

### SUMMARY

The problem addressed by the present invention was that of enabling the provision of rigid polyurethane or polyisocyanurate foams that have particularly advantageous use properties, such as, in particular, good compression hardness and/or indentation hardness even after a short reaction time. At the same time, however, the influence on the rise profile was preferably to be minimized.

### DETAILED DESCRIPTION

It has now been found that, surprisingly, the use of inventive salts of amino acid derivatives in rigid PU foam production leads to rigid PU foams having improved use properties. More particularly, trimerization is improved, as a result of which the foams cure more quickly, meaning that they have a high compression hardness and high indentation hardness at an early juncture. It is also a particular advantage of the present invention that the use of the amino acid derivatives according to the invention nevertheless enables minimization of the influence on the rise profile. This is very advantageous since problems can otherwise occur with the flowability of the reaction mixture, which leads to considerable processing problems.

By the solution according to the invention, it is thus possible to produce rigid PU foam-based products, for example insulation panels or cooling units with very particularly high quality, and to make the processes for production of the rigid PU foams more efficient.

An additional advantage of the invention is the good environmental toxicology classification of the chemicals used, especially of the salts of amino acid derivatives.

The invention has the further advantage that it can help to produce rigid PU foams having a low level of foam defects.

The invention provides a composition for production of rigid polyurethane foam, comprising at least one isocyanate component, a polyol component, optionally a foam stabilizer, optionally blowing agent,

wherein the composition contains at least one catalyst that catalyses the formation of a urethane or isocyanurate bond,

wherein the catalyst comprises salts of amino acid derivatives.

The inventive salts of amino acid derivatives are derivable in a formal sense from the reaction of aromatic carboxylic acids and amino acids; they are especially also obtainable by reaction of amino acids and aromatic carboxylic acids, aromatic carboxylic esters, aromatic carbonyl halides and/or aromatic carboxylic anhydrides, which is a preferred embodiment of the invention. The conversion to the salt can be undertaken here by the conventional methods, for example by reaction with the customary bases, for example KOH, NaOH or corresponding ammonium hydroxides.

Particularly preferred inventive salts of amino acid derivatives satisfy the following formula (I):

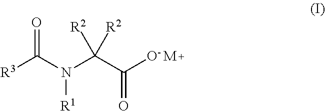

in which

R³ is an aromatic radical, optionally polycyclic aromatic radical, that may have substitutions, optionally also further carboxy functions to which further amino acids may be attached,

where R³ is preferably

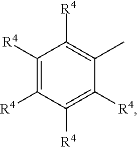

R¹, R², R⁴ are independently H, C₁ to C₁₈ alkyl, alkenyl, aryl or alkylaryl, which may also be substituted,

M⁺ is a cation, such as preferably alkali metal cation or ammonium cation or a substituted ammonium cation, preferably Li⁺, Na⁺, K⁺, Rb⁺, Cs⁺ or substituted ammonium cation such as advantageously tetraalkylammonium, trialkylhydroxyalkylammonium, benzyltrialkylammonium, tetramethylammonium, tetraethylammonium, tetrabutylammonium, tetrapropylammonium, dimethyldiallylammonium, trimethyl(2-hydroxypropyl)ammonium, triethyl(2-hydroxypropyl)ammonium, tripropyl(2-hydroxypropyl)ammonium, tributyl(2-hydroxypropyl)ammonium, dimethylbenzyl(2-hydroxypropyl)ammonium, dimethylbenzyl(2-hydroxyethyl)ammonium and combinations thereof.

It is especially preferable here that R³ is phenyl, alkylphenyl, or is a radical that derives from phthalic acid, isophthalic acid, terephthalic acid or pyromellitic acid.

In a particularly preferred embodiment, the salts derive from amino acid derivatives of the following formula (II):

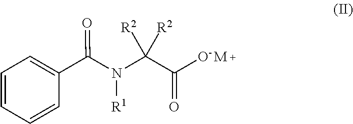

with R¹, R², M⁺ as defined above,

where R² in each case is preferably H,

where R¹ and R² are further preferably each H,

where R¹ and R² are especially each H and M⁺ is Na⁺, K⁺ or NR¹₄₊, R¹ as defined above.

Particularly preferred structures are accordingly:

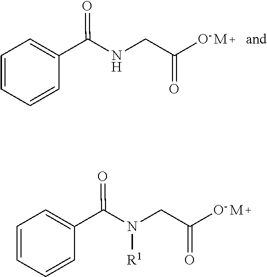

with M⁺ and r¹as defined above.

Particular preference is given to the salts of hippuric acid

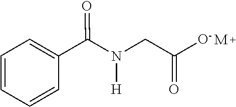

with M⁺ as defined above, preferably sodium, potassium or ammonium as cation, especially preferably the sodium salt:

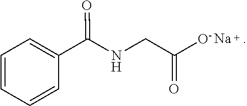

The salts of the invention can be prepared by the known methods.

Hippuric acid and its salts are commercially available. The preparation is known to the person skilled in the art. For example, hippuric acid can be prepared by reaction of benzoyl chloride with glycine (Schotten-Baumann method). Amidation on the basis of benzoic ester (methyl ester) and glycine is likewise possible. The preparation of the salts in that case is undertaken, for example, with the appropriate bases, for example KOH, NaOH or corresponding ammonium hydroxides.

Technical grade quality is often sufficient for use in PU foams since any secondary constituents from the preparation processes do not affect the PU foam production. This is a further considerable advantage of the invention.

In a preferred embodiment of the invention, the salts according to the invention can be added to the reaction mixture in a carrier medium. Carrier media used may be all substances suitable as solvent. Useful examples include glycols, alkoxylates or oils of synthetic and/or natural origin. The use of a carrier medium for the inventive salts of amino acid derivatives is a preferred embodiment of the invention. The salts according to the invention may also be used as part of compositions with different carrier media.

In a preferred embodiment of the invention, the total proportion by mass of salts according to the invention in the finished polyurethane foam is from 0.01% to 10% by weight, preferably from 0.1% to 5% by weight.

In a preferred embodiment of the invention, the composition according to the invention comprises water and/or blowing agents, optionally at least one flame retardant and/or further additives that are advantageously usable in the production of rigid polyurethane foam. As well as the salt according to the invention, it is also possible for further catalysts to be present.

A particularly preferred composition according to the invention contains the following constituents:

a) at least one isocyanate-reactive component, especially polyols

b) at least one polyisocyanate and/or polyisocyanate prepolymer

c) a catalyst according to the invention as described above (inventive salts of amino acid derivatives),

d) (optionally) further catalysts,

e) (optionally) a foam-stabilizing component based on siloxanes or other surfactants,

f) one or more blowing agents,

g) further additives, fillers, flame retardants, etc.

Individual usable components (identified here as a) to g)) are described in more detail further down. Component c) has already been described.

In the composition according to the invention, the proportion by mass of inventive salt c) based on 100 parts by mass of polyol component a) is preferably from 0.1 to 10 pphp, more preferably from 0.2 to 5 pphp and especially preferably from 0.5 to 3 pphp.

The present invention further provides a process for producing rigid polyurethane foam, by reacting one or more polyol components with one or more isocyanate components, wherein the reaction is effected in the presence of a catalyst that catalyses the formation of a urethane or isocyanurate bond,

wherein the catalyst comprises salts of amino acid derivatives that have been described above, especially using a composition as described above. It is also possible here to use further catalysts as well as the salt according to the invention.

It is preferable here that the salts of amino acid derivatives are supplied to the reaction mixture for production of the rigid PU foam in a carrier medium, preferably comprising glycols, alkoxylates or oils of synthetic and/or natural origin.

The invention further provides for the use of salts of amino acid derivatives that have been described above as catalysts in the production of rigid polyurethane foams, preferably for improving the use properties of the rigid polyurethane foam, especially for increasing the compression hardness of the rigid polyurethane foam at an early juncture compared to rigid polyurethane foams that have been produced without the salts of amino acid derivatives, compression hardness determinable to DIN EN ISO 844:2014-11.

The invention further provides a rigid polyurethane foam obtainable by the process according to the invention as described above.

The present invention additionally provides for the use of rigid polyurethane or polyisocyanurate foams according to the invention for thermal insulation purposes, preferably as insulation boards and insulant, and also for cooling apparatuses that include a rigid polyurethane or polyisocyanurate foam according to the invention as insulating material.

Individual usable components (identified here as a) to g)) are described in more detail below. Component c) has already been described.

Polyols suitable as polyol component a) for the purposes of the present invention are all organic substances having one or more isocyanate-reactive groups, preferably OH groups, and also formulations thereof. Preferred polyols are all polyether polyols and/or polyester polyols and/or hydroxyl-containing aliphatic polycarbonates, especially polyether polycarbonate polyols, and/or polyols of natural origin, called “natural oil-based polyols” (NOPs), that are customarily used for production of polyurethane systems, especially polyurethane coatings, polyurethane elastomers or foams. The polyols typically have a functionality of from 1.8 to 8 and number-average molecular weights in the range from 500 to 15 000. The polyols having OH numbers in the range from 10 to 1200 mg KOH/g are typically used.

It is possible to use polyether polyols. These can be prepared by known methods, for example by anionic polymerization of alkylene oxides in the presence of alkali metal hydroxides, alkali metal alkoxides or amines as catalysts and by addition of at least one starter molecule which preferably contains 2 or 3 reactive hydrogen atoms in bonded form, or by cationic polymerization of alkylene oxides in the presence of Lewis acids, for example antimony pentachloride or boron trifluoride etherate, or by double metal cyanide catalysis. Suitable alkylene oxides contain from 2 to 4 carbon atoms in the alkylene radical. Examples are tetrahydrofuran, 1,3-propylene oxide, 1,2-butylene oxide and 2,3-butylene oxide; ethylene oxide and 1,2-propylene oxide are preferably used. The alkylene oxides can be used individually, cumulatively, in blocks, in alternation or as mixtures. Starter molecules used may especially be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2- and -1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule is dependent on the respective field of application of the resulting polyether polyol in the production of polyurethane.

It is possible to use polyester polyols. These are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having 2 to 12, more preferably having 2 to 6, carbon atoms, preferably trimethylolpropane and glycerol.

It is possible to use polyether carbonate polyols. These are polyols containing carbon dioxide in the bonded form of the carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO2 as comonomer is very advantageous in environmental terms, since this reaction constitutes the conversion of a greenhouse gas to a polymer. The preparation of polyether polycarbonate polyols by addition of alkylene oxides and carbon dioxide onto H-functional starter substances using catalysts has long be known. Various catalyst systems can be used here: The first generation was that of heterogeneous zinc or aluminium salts, as described, for example, in U.S. Pat. No. 3,900,424 or U.S.Pat. No. 3,953,383. In addition, mono- and binuclear metal complexes have been used successfully for copolymerization of CO2 and alkylene oxides (WO 2010/028362, WO 2009/130470, WO 2013/022932 or WO 2011/163133). The most important class of catalyst systems for the copolymerization of carbon dioxide and alkylene oxides is that of double metal cyanide catalysts, also referred to as DMC catalysts (U.S. Pat. No. 4,500,704, WO 2008/058913). Suitable alkylene oxides and H-functional starter substances are those also used for preparing carbonate-free polyether polyols, as described above.

It is possible to use polyols based on renewable raw materials, “natural oil-based polyols” (NOPs). NOPs for production of polyurethane foams are of increasing interest with regard to the limited availability in the long term of fossil resources, namely oil, coal and gas, and against the background of rising crude oil prices, and have already been described many times in such applications (WO 2005/033167; US 2006/0293400, WO 2006/094227, WO 2004/096882, US 2002/0103091, WO 2006/116456 and EP 1678232). A number of these polyols are now available on the market from various manufacturers (WO2004/020497, US2006/0229375, WO2009/058367). Depending on the base raw material (e.g. soya bean oil, palm oil or castor oil) and the subsequent workup, polyols having a different profile of properties are the result. It is possible here to distinguish essentially between two groups: a) polyols based on renewable raw materials which are modified such that they can be used to an extent of 100% for production of polyurethanes (WO2004/020497, US2006/0229375); b) polyols based on renewable raw materials which, because of the processing and properties thereof, can replace the petrochemical-based polyol only in a certain proportion (WO2009/058367).

A further class of usable polyols is that of the so-called filled polyols (polymer polyols). A feature of these is that they contain dispersed solid organic fillers up to a solids content of 40% or more. SAN, PUD and PIPA polyols are among useful polyols. SAN polyols are highly reactive polyols containing a dispersed copolymer based on styrene-acrylonitrile (SAN). PUD polyols are highly reactive polyols containing polyurea, likewise in dispersed form. PIPA polyols are highly reactive polyols containing a dispersed polyurethane, for example formed by in situ reaction of an isocyanate with an alkanolamine in a conventional polyol.

A further class of useful polyols are those which are obtained as prepolymers via reaction of polyol with isocyanate in a molar ratio of preferably 100:1 to 5:1, more preferably 50:1 to 10:1. Such prepolymers are preferably made up in the form of a solution in polymer, and the polyol preferably corresponds to the polyol used for preparing the prepolymers.

A preferred ratio of isocyanate and polyol, expressed as the index of the formulation, that is to say as stoichiometric ratio of isocyanate groups to isocyanate-reactive groups (e.g. OH groups, NH groups) multiplied by 100, is in the range from 10 to 1000, preferably 40 to 350. An index of 100 represents a molar reactive group ratio of 1:1.

Isocyanate components b) used are preferably one or more organic polyisocyanates having two or more isocyanate functions. Polyol components used are preferably one or more polyols having two or more isocyanate-reactive groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Isocyanates are more preferably used in a range of from 60 to 200 mol %, relative to the sum total of isocyanate-consuming components.

Specific examples here are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, naphthalene diisocyanate, diethyltoluene diisocyanate, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates can be used individually or in the form of mixtures thereof. It is likewise possible to use corresponding “oligomers” of the diisocyanates (IPDI trimer based on isocyanurate, biurets, uretdiones). In addition, the use of prepolymers based on the abovementioned isocyanates is possible.

It is also possible to use isocyanates which have been modified by the incorporation of urethane, uretdione, isocyanurate, allophanate and other groups, called modified isocyanates.

Particularly suitable organic polyisocyanates which are therefore used with particular preference are various isomers of toluene diisocyanate (toluene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, WO 00/58383, US 2007/0072951, EP 1678232 and WO 2005/085310, which are hereby fully incorporated by reference.

Optional catalysts d) may be used in addition to the catalyst according to the invention, i.e. the salts of amino acid derivatives as described above. Suitable optional catalysts d) in the context of the present invention are all compounds which are able to accelerate the reaction of isocyanates with OH functions, NH functions or other isocyanate-reactive groups and with isocyanates themselves. It is possible here to make use of the customary catalysts known from the prior art, including, for example, amines (cyclic, acyclic; monoamines, diamines, oligomers having one or more amino groups), ammonium compounds, organometallic compounds and metal salts, preferably those of potassium, tin, iron, bismuth and zinc. In particular, it is possible to use mixtures of a plurality of components as catalysts.

As component e) it is possible to use Si-free surfactants or else organomodified siloxanes. The use of such substances in rigid foams is known. In the context of this invention, it is possible here to use all compounds that assist foam production (stabilization, cell regulation, cell opening, etc.). These compounds are sufficiently well known from the prior art.

Corresponding siloxanes usable in the context of this invention are described, for example, in the following patent specifications: CN 103665385, CN 103657518, CN 103055759, CN 103044687, US 2008/0125503, US 2015/0057384, EP 1520870 A1, EP 1211279, EP 0867464, EP 0867465, EP 0275563. The aforementioned documents are hereby incorporated by reference and are considered to form part of the disclosure-content of the present invention. The use of polyether-modified siloxanes is particularly preferred.

The use of blowing agents f) is optional, according to which foaming process is used. It is possible to work with chemical and physical blowing agents. The choice of the blowing agent here depends greatly on the type of system.

According to the amount of blowing agent used, a foam having high or low density is produced. For instance, foams having densities of 5 kg/m³ to 900 kg/m³ can be produced. Preferred densities are 8 to 800, more preferably 10 to 600 kg/m³, especially 30 to 150 kg/m³.

Physical blowing agents used may be corresponding compounds having appropriate boiling points. It is likewise possible to use chemical blowing agents which react with NCO groups to liberate gases, for example water or formic acid. Examples of blowing agents include liquefied CO2, nitrogen, air, volatile liquids, for example hydrocarbons having 3, 4 or 5 carbon atoms, preferably cyclopentane, isopentane and n-pentane, hydrofluorocarbons, preferably HFC 245fa, HFC 134a and HFC 365mfc, chlorofluorocarbons, preferably HCFC 141b, hydrofluoroolefins (HFO) or hydrohaloolefins, for example 1234ze, 1234yf, 1233zd(E) or 1336mzz, oxygen compounds such as methyl formate, acetone and dimethoxymethane, or chlorinated hydrocarbons, preferably dichloromethane and 1,2-dichloroethane.

Suitable water contents for the purposes of this invention depend on whether or not one or more blowing agents are used in addition to the water. In the case of purely water-blown foams the values are preferably 1 to 20 pphp; when other blowing agents are used additionally the amount of water used is reduced to preferably 0.1 to 5 pphp.

Additives g) used may be any substances which are known from the prior art and are used in the production of polyurethanes, especially polyurethane foams, for example crosslinkers and chain extenders, stabilizers against oxidative degradation (known as antioxidants), flame retardants, surfactants, biocides, cell-refining additives, cell openers, solid fillers, antistatic additives, nucleating agents, thickeners, dyes, pigments, color pastes, fragrances, emulsifiers, etc.

The process according to the invention for producing rigid PU foams can be conducted by the known methods, for example by manual mixing or preferably by means of foaming machines. If the process is carried out by using foaming machines, it is possible to use high-pressure or low-pressure machines. The process according to the invention can be carried out either batchwise or continuously.

A preferred rigid polyurethane or polyisocyanurate foam formulation in the context of this invention results in a foam density of 5 to 900 kg/m³ and preferably has the composition shown in Table 1.

TABLE 1
Composition of a preferred rigid polyurethane
or polyisocyanurate formulation

| Component | Proportion by weight |
|---|---|
| Polyol | 0.1 to 100 |
| Amine catalyst | 0 to 5 |
| Metal catalyst | 0 to 10 |
| Inventive salts (salts of amino acid derivatives) | 0.1 to 10 |
| Foam stabilizer (Si-free or Si-containing) | 0 to 5 |
| Water | 0.01 to 20 |
| Blowing agent | 0 to 40 |
| Further additives (flame retardants, etc.) | 0 to 90 |
| Isocyanate index: 10 to 1000 | |

For further preferred embodiments and configurations of the process of the invention, reference is also made to the details already given above in connection with the composition of the invention.

As already mentioned, the invention further provides a rigid PU foam obtainable by the process mentioned.

In a preferred embodiment of the invention, the polyurethane foam has a density of 5 to 900 kg/m³, preferably 8 to 800, especially preferably 10 to 600 kg/m³, more particularly 30 to 150 kg/m³.

It is especially possible to produce predominantly closed-cell foams. The closed cell content is advantageously >80%, preferably >90%.

The rigid PU foams according to the invention can be used as or for production of insulation materials, preferably insulating panels, refrigerators, insulating foams, roof liners, packaging foams or spray foams.

Particularly in the refrigerated warehouse, refrigeration appliances and domestic appliances industry, for example for production of insulating panels for roofs and walls, as insulating material in containers and warehouses for frozen goods, and for refrigeration and freezing appliances, the PU foams of the invention can be used advantageously.

Further preferred fields of use are in vehicle construction, especially for production of vehicle inner roof liners, bodywork parts, interior trim, cooled vehicles, large containers, transport pallets, packaging laminates, in the furniture industry, for example for furniture parts, doors, linings, in electronics applications.

Cooling apparatuses of the invention have, as insulation material, a PU foam of the invention (polyurethane or polyisocyanurate foam).

The invention further provides for the use of the rigid PU foam as insulation material in refrigeration technology, in refrigeration equipment, in the construction sector, automobile sector, shipbuilding sector and/or electronics sector, as insulation panels, as spray foam, as one-component foam.

The subject matter of the invention will be described by way of example below, without any intention that the invention be restricted to these illustrative embodiments. Where ranges, general formulae or classes of compounds are specified below, these are intended to encompass not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are figures in per cent by weight. When average values are reported below, the values in question are weight averages, unless stated otherwise. Where parameters which have been determined by measurement are reported below, the measurements have been carried out at a temperature of 25° C. and a pressure of 101 325 Pa, unless stated otherwise.

The examples which follow describe the present invention by way of example, without any intention of restricting the invention, the scope of application of which is apparent from the entirety of the description and the claims, to the embodiments cited in the examples.

### EXAMPLES

Foams were produced using the following raw materials:

Stepanpol PS 2352: polyester polyol from Stepan Daltolac R 471: polyether polyol from Huntsman

TCPP: tris(2-chloroisopropyl) phosphate from Fyrol KOSMOS 75 from Evonik Nutrition & Care GmbH, catalyst based on potassium octoate POLYCAT 5 from Evonik Nutrition & Care GmbH, amine catalyst POLYCAT 8 from Evonik Nutrition & Care GmbH, amine catalyst

MDI (44V20): Desmodur 44V20L from Covestro, diphenylmethane 4,4′-diisocyanate (MDI) with isomeric and higher-functionality homologues Tegostab B 8460 from Evonik Nutrition & Care GmbH, foam-stabilizing surfactant

Synthesis Examples for Preparation of the Trimerization Catalysts (salts) According to the Invention

Experiment A: Sodium hippurate (obtainable from Sigma-Aldrich) was dissolved in monoethylene glycol to give a solution containing 25% sodium hippurate

Experiment B:

Hippuric acid (obtainable from Sigma-Aldrich) was dissolved in diethylene glycol, the salt was neutralized with aqueous NaOH and then the water was distilled off under reduced pressure. The sodium hippurate content was adjusted to 30%.

Experiment C: Hippuric acid (obtainable from Sigma-Aldrich) was dissolved in diethylene glycol, the salt was neutralized with aqueous KOH and then the water was distilled off under reduced pressure. The potassium hippurate content was adjusted to 30%.

Experiment D: Reaction of methyl benzoate with glycine in DEG as solvent using sodium methoxide to accelerate the amidation and for salt formation with the hippuric acid formed. The excess methanol was distilled off under reduced pressure. The sodium hippurate content was adjusted to 30%.

Examples: Production of PU Foams

Foaming was carried out by manual mixing. For this purpose, the compounds according to the invention, polyols, flame retardants, catalysts according to the invention or not according to the invention, water, siloxane surfactant and blowing agent were weighed into a beaker and mixed by means of a disc stirrer (6 cm in diameter) at 1000 rpm for 30 s. By reweighing, the amount of blowing agent that had evaporated in the mixing operation was determined and added again. Subsequently, the isocyanate (MDI) was added, and the reaction mixture was stirred with the stirrer described at 3000 rpm for 5 s.

The reaction mixtures were introduced into appropriate beakers having a diameter at the upper edge of 20 cm in order to obtain free-rise foams. The amount of the reaction mixture was chosen such that the tip of the foam dome at the end was 10 to 15 cm above the upper edge of the beaker. During the foaming, the gel time was determined, in order to assess the influence of the catalysts on the speed of foaming.

After 3 minutes, the foam domes were cut off at the upper edge of the beaker, such that a round foam surface was obtained. The indentation hardnesses of the foams were determined at this surface.

Method of Determining Indentation Hardness

For this purpose, the force for indenting a die of diameter 4 cm into the foam was measured. The indentation forces were measured at indentation depth 5 mm. Measurement was effected after 4, 6, 8 and 10 minutes, indenting the die at 4 different points on the cut surface in a circular arrangement.

Method of Determining Compression Hardness

The compression hardnesses of the foams are measured on cubic test specimens with edge length 5 cm to DIN EN ISO 844:2014-11 up to a compression of 10% (the figure reported is the maximum compressive stress that occurred within this measurement range).

Table 2 summarizes the foam formulations used (Form.1 and Form.2).

TABLE 2

| Formulation Example | Form. 1 (PUR) | Form. 2 (PIR) |
|---|---|---|
| Daltolac R 471 | 100 | |
| PS 2352 | | 100 |
| Trimer cat. (inv. salt) | variable | variable |
| POLYCAT 8 | 2.8 | |
| POLYCAT 5 | 0.7 | 0.5 |
| KOSMOS 75 | | 0.7 |
| TEGOSTAB B 8460 | 2 | 2 |
| TCPP | | 15 |
| Water | 2.5 | 0.5 |
| n-Pentane | | 14 |
| Cyclopentane | 13 | |
| MDI (44V20) | approx. 200 | approx. 190 |
| Index | 130 | 255 |

Forming results with the trimerization catalysts according to the invention.

TABLE 3
Summary of the foaming experiments with various catalysts
according to the invention and foam formulations.
The figures reported are the indentation hardnesses in newtons
after the reported time in minutes (after mixing with MDI)

| | | | | Gel | | | | |
|---|---|---|---|---|---|---|---|---|
| Foam | | | Form. | time in | | | | |
| Example | Trimer cat. | Dosage | No. | sec. | 4 min | 6 min | 8 min | 10 min |
| Comp. 1 | amines only | | 1 | 52 | 49 | 117 | 180 | 235 |
| | (non-inv.) | | | | | | | |
| 1 | C | 2 | 1 | 46 | 159 | 259 | 317 | 343 |
| 2 | B | 2 | 1 | 48 | 124 | 209 | 282 | 367 |
| 3 | D | 2 | 1 | 48 | 127 | 201 | 287 | 360 |
| 4 | A | 2 | 1 | 47 | 113 | 203 | 257 | 325 |
| Comp. 2 | Kosmos 75 | 0.7 | 2 | 94 | 87 | 226 | 346 | 435 |
| | only (non- | | | | | | | |
| | inv.) | | | | | | | |
| Comp. 3 | Kosmos 75 | 1.5 | 2 | 49 | 266 | 392 | 460 | 501 |
| | only (non- | | | | | | | |
| | inv.) | | | | | | | |
| 5 | B | 2 | 2 | 66 | 108 | 246 | 380 | 440 |
| 6 | B | 3 | 2 | 63 | 144 | 271 | 389 | 462 |
| 7 | C | 2 | 2 | 63 | 140 | 277 | 392 | 474 |
| 8 | C | 3 | 2 | 60 | 138 | 284 | 398 | 480 |
| 9 | D | 2 | 2 | 67 | 123 | 273 | 391 | 488 |
| 10 | A | 2 | 2 | 66 | 136 | 264 | 389 | 498 |

The foams according to the invention each show distinctly higher indentation hardnesses than Comparative Examples 1 and 2. In Comparative Example 3, with a higher dose of potassium octoate, indentation hardnesses are likewise improved. Here, however, the gel time is shortened by 15 seconds compared to the candidates according to the invention and hence intervenes much more significantly into the rise profile of the foam, which is undesirable.

It is clear from this that the trimerization catalysts according to the invention enable an improvement in curing of the foam with a distinctly smaller reduction in gel time.

This is an enormous advantage since, by virtue of the minor influence on gel time, the processibility of the reaction mixture is maintained, for example with regard to the flowability of the foaming mixture, and the curing of the foam is simultaneously accelerated.

It is clearly apparent from the experiments that the trimerization catalysts according to the invention lead to improved curing of the foam. The very good results described above for the indentation hardnesses of the foams according to the invention correspond to those for compression hardness.

1. A composition for production of rigid polyurethane foam, comprising at least one isocyanate component, a polyol component, optionally a foam stabilizer, optionally blowing agent,
wherein the composition contains at least one catalyst that catalyses the formation of a urethane or isocyanurate bond,
wherein the catalyst comprises salts of amino acid derivatives.

2. The composition according to claim 1, wherein the amino acid derivatives are obtainable by reacting amino acids and aromatic carboxylic acids, aromatic carboxylic esters, aromatic carbonyl halides and/or aromatic carboxylic anhydrides.

3. The composition according to claim 1, wherein the salts of amino acid derivatives satisfy the following formula (I): 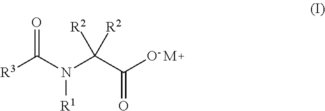
in which
R³ is an aromatic radical, optionally polycyclic aromatic radical, that may have substitutions, optionally also further carboxy functions to which further amino acids may be attached, M⁺ is a cation, such as alkali metal cation or ammonium cation or a substituted ammonium cation.

4. The composition according to claim 3, wherein R³ is phenyl or alkylphenyl, or is a radical that derives from phthalic acid, isophthalic acid, terephthalic acid or pyromellitic acid.

5. The composition according to claim 1, wherein the salts of amino acid derivatives satisfy the following formula (II): 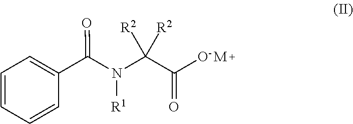
with R¹, R², M⁺ as defined above,
where R² in each case is preferably H,
where R¹ and R² are further preferably each H,
where R¹ and R² are especially each H and M⁺ is Na¹₄⁺, K⁺ or NR¹₄⁺, R¹ as defined above.

6. The composition according to claim 1, wherein the total proportion by mass of salts of amino acid derivatives present, based on the resulting polyurethane foam, is from 0.01% to 10% by weight.

7. A process for producing rigid polyurethane foam, by reacting one or more polyol components with one or more isocyanate components, characterized in that the reaction is effected in the presence of a catalyst that catalyses the formation of a urethane or isocyanurate bond,
wherein the catalyst comprises salts of amino acid derivatives that preferably conform to the specifications of claim 1.

8. The process according to claim 7, wherein the salts of amino acid derivatives are supplied to the reaction mixture for production of the rigid PU foam in a carrier medium, alkoxylates or oils of synthetic and/or natural origin.

9. The use of salts of amino acid derivatives that conform to the specifications of claim 1 as catalyst in the production of rigid polyurethane foams for improving the use properties of the rigid polyurethane foam.

10. The rigid polyurethane foam obtainable by the process according to claim 7.

11. A thermal insulation comprising the rigid polyurethane foam according to claim 10.

12. The composition according to claim 3, wherein R³ is 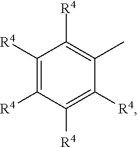
R¹, R², R⁴ are independently H, C₁ to C₁₈ alkyl, alkenyl, aryl or alkylaryl.

13. The composition according to claim 3, wherein M⁺ is an alkali metal cation or ammonium cation or a substituted ammonium cation.

14. The composition according to claim 3, wherein M⁺ is an alkali metal cation selected from the group consisting of Li⁺, Na⁺, K⁺, Rb⁺, Cs⁺.

15. The composition according to claim 3, wherein M⁺ is a substituted ammonium cation selected from the group consisting of tetraalkylammonium, trialkylhydroxyalkylammonium, benzyltrialkylammonium, tetramethylammonium, tetraethylammonium, tetrabutylammonium, tetrapropylammonium, dimethyldiallylammonium, trimethyl(2-hydroxypropyl)ammonium, triethyl(2-hydroxypropyl)ammonium, tripropyl(2-hydroxypropyl)ammonium, tributyl(2-hydroxypropyl)ammonium, dimethylbenzyl(2-hydroxypropyl)ammonium, dimethylbenzyl(2-hydroxyethyl)ammonium and combinations thereof.

16. The composition according to claim 5, wherein
where R² is H.
where R¹ and R² are further preferably each H,
where R¹ and R² are especially each H and M⁺ is Na⁺, K⁺ or NR¹₄⁺, R¹ as defined above.

17. The composition according to claim 5, wherein R¹ and R² are H.

18. The composition according to claim 1, wherein the total proportion by mass of salts of amino acid derivatives present, based on the resulting polyurethane foam, is from 0.1% to 5% by weight.

19. The process for producing rigid polyurethane foam, by reacting one or more polyol components with one or more isocyanate components, characterized in that the reaction is effected in the presence of a catalyst that catalyses the formation of a urethane or isocyanurate bond, comprising the composition according to claim 1.

20. The process according to claim 7, wherein the salts of amino acid derivatives are supplied to the reaction mixture for production of the rigid PU foam in a carrier medium selected from the group consisting of a glycol alkoxylates, and an oil of synthetic or natural origin.
